(19) United States
(12) Patent Application Publication
(10) Pub. No.: US 2009/0136212 A1
(43) Pub. Date: May 28, 2009

(54) SELF CONTAINED PROJECTION MODULE SUITABLE FOR RETAIL AND METHOD

(76) Inventor: SCOTT V. KLEIN, ST. LOUIS, MO (US)

Correspondence Address: CHARLES C. MCCLOSKEY, 763 S. NEW BALLAS ROAD STE. 170, ST. LOUIS, MO, 63141, US

(21) Appl. No.: 12/276,052

(22) Filed: Nov. 21, 2008

Related U.S. Application Data
(60) Provisional application No. 60/990,851, filed on Nov. 28, 2007.

(51) Int. Cl. H04N 5/00; G06F 17/00

(52) U.S. Cl. 386/117; 705/400

(57) ABSTRACT

A self contained projection module, combines content with projection capability for audio and video in a single compact unit. The module adapts cell phone photography equipment with small scale projection systems into a compact portable unit. The module combines a rechargeable battery, digital disc media, digital memory module, flash memory storage, pico-projection, and wireless connectivity among other components. The controls of the present invention have a convenient location and simplicity of use. The controls include an LCD screen, power button, and an antenna for communication with remote controls, generally in the infra red.

### CROSS REFERENCE TO RELATED APPLICATION

This non-provisional application claims priority to the provisional application Ser. No. 60/990,851 with a filing date of Nov. 28, 2007 and is commonly owned by the same inventor.

### BACKGROUND OF THE INVENTION

The self contained projection module suitable for retail generally relates to portable audio visual systems and more specifically to a system where the projection equipment, power supply, and content fit within a single unit. A unique aspect of the present invention is a single unit having content suitable for rental, or purchase, by consumers and then immediate use at the consumer's choice of location without existing projection equipment.

Presently, consumers and businesses face a wide variety of portable and home entertainment devices. Those devices can portray a variety of content from music and graphics to educational programs and full length movies. The content for the devices comes generally upon a DVD, CD, Blu-ray® disc, and direct download over the internet, among other delivery means. These delivery means for content also run the risk of piracy. Presently, DVD and CD are readily duplicated by pirates and rushed into the hands of all too eager consumers. The motion picture and recording industries have taken on pirates of video and audio but, the scourge continues.

### DESCRIPTION OF THE PRIOR ART

The difficulty in providing a self contained projection module appears in comparison to present day video displays. To watch a video, either a lesson, a movie, a presentation, and the like, a user has a projector for wall display or a monitor, a content provider such as a laptop computer connected to a projector or a player connected to a monitor, and content placed into a computer or player. Often, the user obtains the content from a third party, such as a store, at another location either in person or over the internet as on-line delivery of content grows in popularity. Though users collect and operate this equipment and its content, doing so requires an investment in equipment that often becomes attached to a location and bulky for transport. Many a tale has circulated among those who give presentations and those who watch presentations of equipment that refuses to work, leaving no projected presentation for an audience to view. Users have to track all of this equipment, content, and cables to make all of it work properly to project video and to an extent audio. Some equipment, such as digital projectors, slide projectors, and computers require external power sources.

Some existing devices, such as iPods®, combine content, player device, and display screen in a small form. However, these existing devices lack the ability to project a focused image outwardly for a group of users to view.

Thus, prior art devices and combinations of equipment do not provide for focused projection of video content on a compact, single piece of equipment. The present invention stores content, such as instructional material, plays the content, and projects the content, whether video or audio, all upon one piece of equipment readily carried by a user.

### SUMMARY OF THE INVENTION

The present invention provides a device and method to thwart piracy and meet the projection needs of consumers and businesses. The present invention removes the necessity of separate home entertainment devices, such as a stereo system, DVD player, VCR, and television among others. The present invention combines content with a projection system, both audio and video, into a compact single unit for leasing or purchase by consumers, primarily those consumers interested in instructional media such as self help, equipment operations, safety procedures, and the like. Other consumers, such as givers of presentations and watchers of movies will also use the present invention.

The present invention overcomes the limitations of the prior art. That is, the art of the present invention, a self contained projection module, combines content with the equipment to project audio and video into a compact unit ready for use at a location selected by the user. The present invention adapts the technology of cell phone photography with small scale projection systems into a unit similar to the size of a DVD rental disk package. The present invention combines a rechargeable battery, digital disc media, digital memory module, flash memory storage, pico-projection, and wireless connectivity among other components. The controls of the present invention have a convenient location and simplicity of use. The controls include an LCD screen, power button, and remote antenna similar to those currently used with remote controls of existing home entertainment devices, generally infra red controllers.

The module of the present invention, particularly the memory module, also has wireless connectivity, such as Bluetooth®, that allows the invention to communicate information and content to a base station using infra-red, radio, or microwave. The connectivity also allows for playing various computer games through the module using controllers supplied by the user or rented from the retailer of the modules. The computer game software allows for renting on a time basis, such as pay per play or per day. The connectivity also allows for two way interaction where a user can provide input to the software to alter the progression of a lesson or of a game. The controllers supported by the module include a mouse, digital drawing tablet, digital pointer, and retinal projection eye-wear among others. The module has an alternate embodiment where a keyboard or other input/output device is projected upon a surface for a user to touch or otherwise manipulate.

Further, the present invention incorporates a retailing method. This method provides for the recharging of batteries, loading and erasing of content, tracking of royalties and licensing fees due, and eventual recycling or disposal of the invention at the end of its lifecycle. This method has a secure database of content at the retailing location that undergoes regular updating via a server, or central computer system, from content providers, such as movie studios and software publishers. In the method, the device of the present invention docks at a base station. The base station provides electrical power to recharge the batteries incorporated into the device and to update the content loaded upon the device. The base station communicates to the server. The server then monitors usage of the content supplied to the device by title, number of viewings, trailers and advertisements viewed. Monitoring software also documents the number of incidents where the viewer paused the content and the total time of viewing the content. The monitoring software provides data for licensing and royalty calculations at all levels in the distribution chain of content.

The retailing method applies to content of varying description including but not limited to digital textbooks, educational materials, videos, music, music videos, audio books, computer software, computer presentations, and computer games, among other things. To augment the retailing method, the present invention suggests alternate equipment and layouts such as a café for leisurely sampling of audio and video titles upon the devices.

There has thus been outlined, broadly, the more important features of the invention in order that the detailed description thereof that follows may be better understood and that the present contribution to the art may be better appreciated. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a self contained projection module suitable for retail with onboard content, primarily instructional material, and an onboard projection system for video and audio.

Another object is to provide such a self contained projection module that has a size less than a DVD disk container.

Another object is to provide such a self contained projection module that prevents users of the module from copying content contained thereon.

Another object is to provide such a self contained projection module that users can rent and use at a desired location and then return to a convenient retail site.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### DESCRIPTION OF THE DRAWINGS

In referring to the drawings,

FIG. 1 shows a top view of the device of the present invention;

FIG. 2 describes the major components within the device;

FIG. 3 provides a top view of the device suitable for computer presentations;

FIG. 4 describes the major components within the device for computer presentations;

FIG. 5 illustrates a perspective view of the invention ready to display video; and,

FIG. 6 shows a retail counter for recharging the device of the present invention.

The same reference numerals refer to the same parts throughout the various figures.

### DETAILED DESCRIPTION OF THE PREFERRED EMBODIMENT

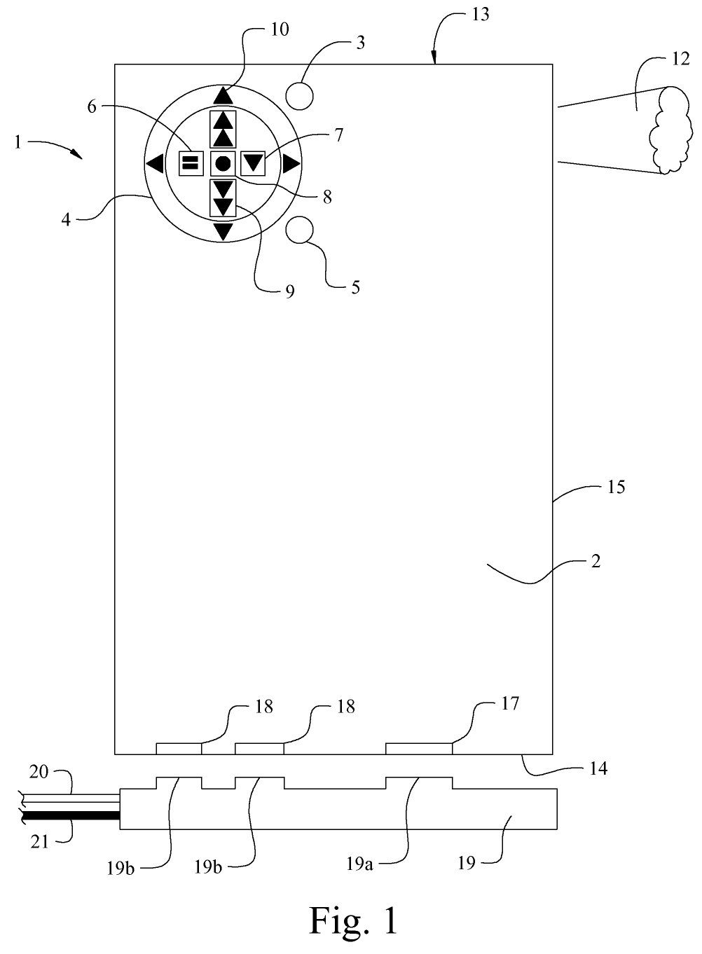

The present invention overcomes the prior art limitations by providing projection equipment and content in a single, small, compact, self contained unit. Turning to FIG. 1, the self-contained projection module is seen from the top ready to project video from content loaded into the module. The module 1 has a casing 2 here shown rectangular, in plan view, though other shapes are foreseen. The casing provides protection and structure to the components contained therein. Generally, the module has a size less than the dimensions of a single DVD disk container, particularly the thickness, that is less than 0.6 inches. Upon the top, the casing has a power button 3 that delivers electrical power from battery storage, as later shown, to operate the module. Proximate the power button, the module has controls 4 here shown as a menu button 5 and typical controls for pause 6, play 7, stop 8, fast forward 9, reverse 10, and a biaxial control ring 11 that directs a cursor projected by the module. These controls generally affect the position of the image 12 when projected upon a distant surface, typically a wall, but also the side of a building, vehicle, or tent.

The casing has two opposite ends, with one end 13 proximate the projected image and the other end 14 away from the image. The ends are joined by a mutually parallel and spaced apart front 15 and an opposite back 16. Opposite the end of the projection, the casing has an end 14 where below the image position controls, the module receives content through a data port 17 and electrical power through at least one contact 18, here shown as two contacts. The data port has various forms such as S-video, coaxial cable, Ethernet port, serial port, USB, Flash, and parallel port along with audio jacks. The contacts receive electricity for battery recharging and thus have a cooperative form, such as pin and socket, or male and female. The contacts are preferably pin type in the embodiment of the present invention to fit sockets for transmitting data and supplying electrical power to the module.

The module connects to a charging unit 19 that temporarily joins with the data port 17 and the contacts 18 through complementary connectors. The data portion of the charging unit provides content to the module, retrieves information from the module such as user and usage data, and erases content from the module. The data portion has a fitting 19a that cooperates with that of the module such as S-video, coaxial cable, Ethernet cable, serial port, USB, Flash, and parallel port along with audio jacks. Opposite the data portion, the charging unit also has fittings 19b, typically cylindrical receptacles that fit upon the pins of the contacts 18. Opposite the fittings and connections, the charging unit has a data cable 20 and a power cable 21 in communication with the respective data sources and electrical supplies.

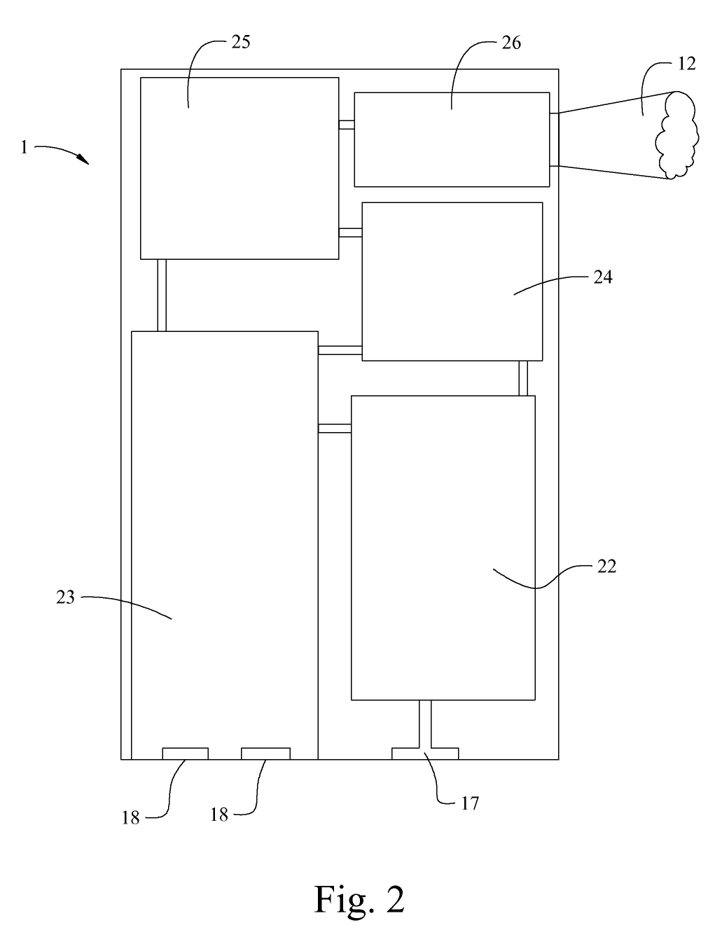

Within the module, FIG. 2 describes the components of the present invention that allow its portability and secure use of content. Inside of the casing 2, the module 1 has a memory component 22 in communication with the data port 17. The memory component has digital storage capability in excess of 500 gigabytes. Additionally, the memory component provides wireless connectivity of the module to an available network. The wireless connectivity supplements the transfer of information through the data port. Opposite the memory component, the module contains a rechargeable battery 23. The battery provides sufficient current at a stepped down voltage for operating the module. The battery is in communication with the contacts 18 for receiving electricity from time to time, such as when the module is returned to a rental location. The battery includes nickel metal hydride and lithium ion formulations at present though other battery formulations are foreseen. Generally the battery provides sufficient electrical power to the module for four continuous hours of operation when projecting video and audio.

The module operates under the coordination of a data management component 24. This component receives electrical power from the battery 23 and accesses the memory component 22. This component 24 selects the data from the memory component as needed to fulfill the instructions of the user of the module. This component 24 further coordinates operation of the wireless connectivity of the module to outside telecommunications networks. As the module projects video, this component 24 sends video data for projection through a video controller 25. The video controller assembles the data in digital form into a format suitable for projection. The controller operates upon electrical power provided by the battery as well. The data management component also supplies audio soundtracks to an audio controller that then projects sound from the module through an audio component, such as a speaker.

With the data assembled, the video controller releases a stream of data to an integrated photonic component 26. The photonic component generates a visual image electronically and then projects the image outwardly from the module as in 12. The photonic component takes in the video data from the controller and converts it to photons of the primary colors which are then electronically blended and focused into an image then projected and seen by the users of the module. The photonic component routes photons, from lasers and other light sources, through its circuitry using fiber optics and other optical transmission modes. Further the photonic component includes pico-projection for ready display of images.

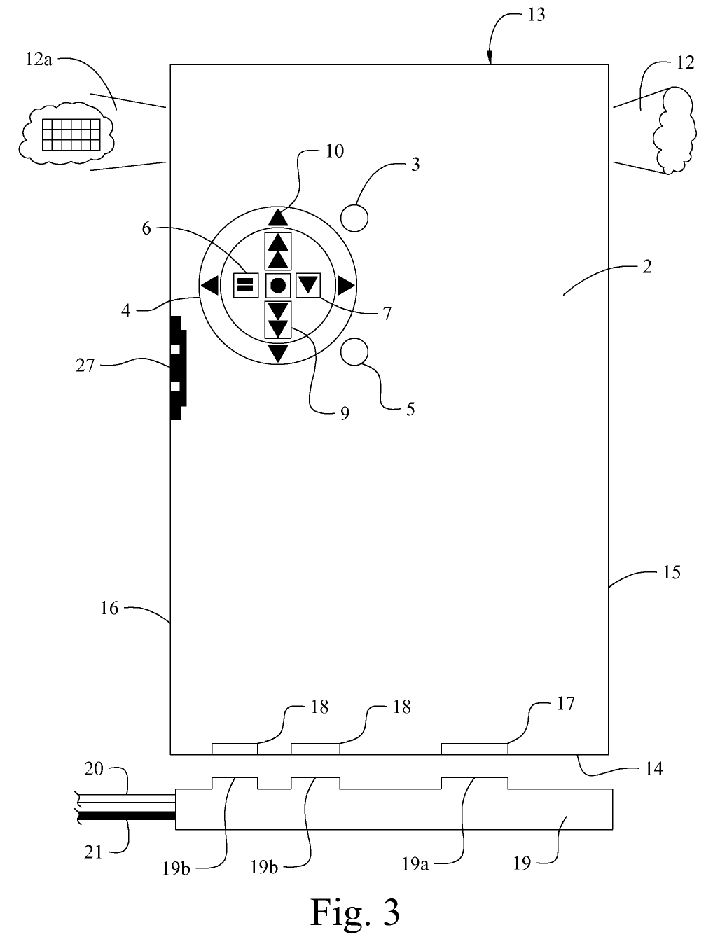

The embodiment for projecting software, in FIG. 3, has a similar outward arrangement as the preferred embodiment previously shown. Seen from the top, the software projection module projects video images from software placed therein and manipulated by external devices or the projected keyboard. The module 1 has a rectangular casing 2 as before but other shapes are foreseen. Generally, this module has a size less than the dimensions of a single DVD cassette and more particularly less than a laptop computer. Upon the top, the casing has a power button 3 that delivers electrical power from the battery 23 to operate the module. Proximate the power button, the module has controls 4 here shown as a menu button 5 and typical controls for pause 6, play 7, stop 8, fast forward 9, reverse 10, and a biaxial control ring 11 that directs a cursor projected by the module. These controls generally affect the position of the image 12 and the projected keyboard 12a when projected upon a distant surface, typically a wall. These controls have a location inwardly compared to the preferred embodiment of the invention.

As before, the casing has two ends with one end 13 proximate the projected image and the other end 14 away from the projection having the data port 17 and the charging contacts 18. The ends are joined by a mutually parallel and spaced apart front 15 and an opposite back 16. Opposite the end of the projection, the other end 14 allows the module to receive content through a data port 17 and electrical power through at least one contact 18 here shown as two. The data port has various forms such as S-video, coaxial cable, Ethernet port, serial port, USB, Flash, and parallel port along with audio jacks. The contacts receive electricity for battery recharging and thus have cooperative form, such as pin and cylinder. The contacts are preferably pin type in the embodiment of the present invention. Generally upon the back 16, the module has at least one external device port 27.

The module connects to a common charging unit 19 that temporarily joins with the data port 17 and the contacts 18 through complementary connectors. The charging unit supplies electrical power and data to both the video and software projecting embodiments of this invention. The data portion of the charging unit provides content, generally software, to the module, retrieves information from the module such as user data, and erases content from the module. The data portion has a fitting 19a that cooperates with that of the module such as S-video, coaxial cable, Ethernet cable, serial port, USB, Flash, and parallel port along with audio jacks. Opposite the data portion, the charging unit supplies electricity to the module through a power portion. The power portion has fittings 19b, typically cylindrical receptacles that fit upon the pins of the contacts 18. Opposite the fittings and connections, the charging unit has a data cable 20 and a power cable 21 in communication with the respective data sources and electrical supplies.

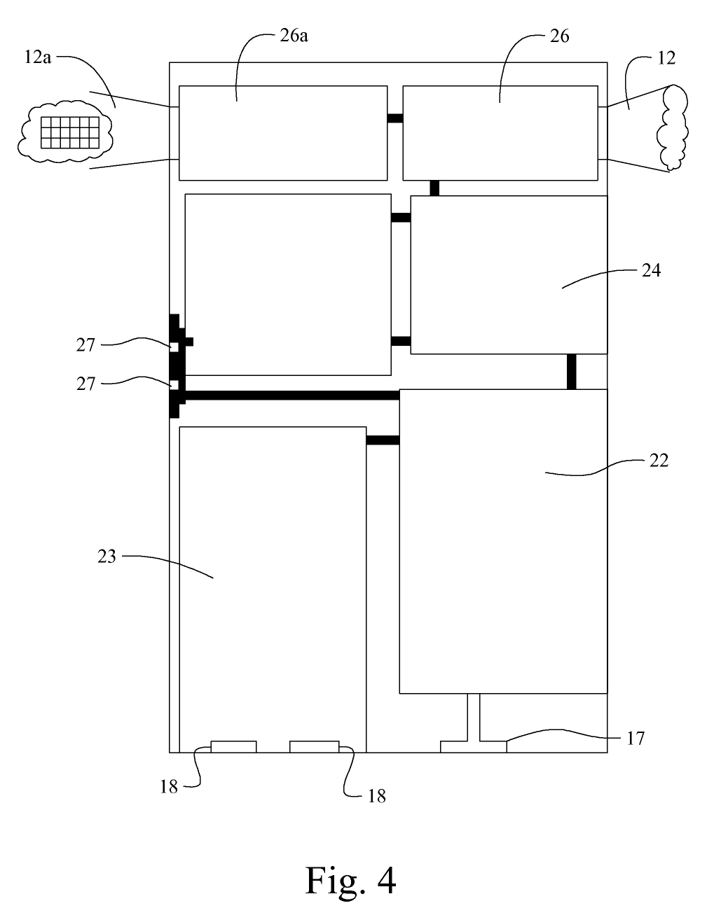

Beyond video and audio for entertainment, the module also displays images from a computer using the components shown in FIG. 4. As above, inside of the casing 2, the module 1 has a memory component 22 in communication with the data port 17 where the memory component stores in excess of 500 gigabytes of data. Additionally, the memory component provides wireless connectivity of the module to any available network within range of the module. The wireless connectivity supplements the transfer of information through the data port. Additionally, the module in this embodiment has at least two external device ports 27. The external device ports connect the module to input devices generally, such as a thumb drive, a digital pointer, a keyboard and a mouse among others. Opposite the memory component, the module contains a rechargeable battery 23 for providing sufficient current at a stepped down voltage for operating the module. The battery is in communication with the contacts 18 for receiving electricity from time to time. Generally the battery provides sufficient electrical power to the module for four continuous hours of operation.

The module operates under the coordination of a data management component 24 powered by the battery 23 and that accesses the memory component 22. This component 24 selects the data from the memory component as needed to fulfill the instructions of the user of the module and to direct the wireless connectivity of the module to outside telecommunications networks. As the module projects video, this component 24 sends video data towards projection through a video controller 25. The video controller assembles the data from digital form into a format suitable for projection. The controller operates upon electrical power provided by the battery as well.

With the data assembled, the video controller releases a stream of data to an integrated photonic component 26. As before, the photonic component generates a visual image electronically and then projects the image outwardly from the module as in 12. The photonic component takes the video data from the controller and converts it to photons of the primary colors which are then electronically blended and focused into an image then projected and seen by the users of the module. In this embodiment, the photonic component has a secondary photonic component 26a generally opposite. The secondary photonic component projects an image of a keyboard 12a or other input device upon a surface and detects when a user touches a section of the keyboard or operates the input device as projected. A user can operate this embodiment and any software placed therein without using a separate physical keyboard and mouse.

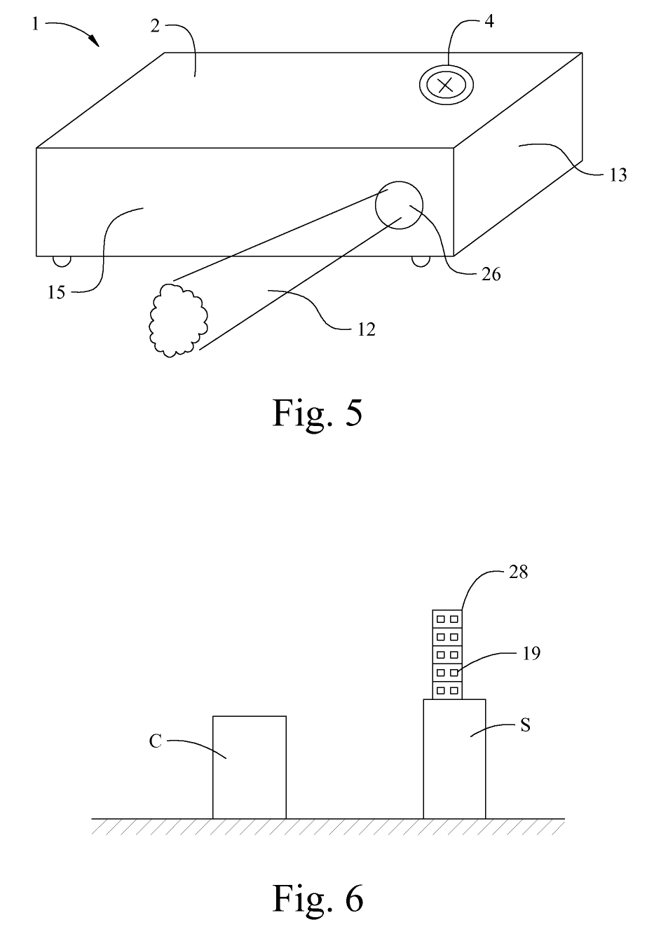

Having described the module internally and from the top, FIG. 5 shows the module 1 projecting an image 12 as during usage. The module has a general box like form with the photonics component 26 providing an image forward of the module. The photonics component directs the image outwardly from the front 15 of the module. The image forms after the controls 4 are pressed and selected upon the top of the casing 2. The photonics component is along one edge of the module, here the end 13. The module has a plurality of feet below the photonics component to raise the module above a supporting surface for ventilation and abrasion prevention. As this figure shows, the module of the present invention can be readily moved and transported by a user. Incorporating data and video storage with a projector, the present invention performs image projection upon a single piece of equipment.

From time to time, the modules 1 of the invention have content that becomes old or stale to the users. Users often seek the most current game, entertainment, or instructional material. FIG. 6 shows an arrangement in a retail environment for supplying electrical power and fresh content to a plurality of modules. The modules reach a growing market niche for ready video delivery coming from the combination of content rental and micro-projection, longer lasting batteries, and wireless connectivity. Once the battery has depleted or the content has become stale, a user returns a module to a retail location such as a store or a kiosk. At the store, the proprietor has a counter C upon which a user places a module. The proprietor then collects the module and places the end 14 with the contacts 18 and data port 17 into a base station 28 of slots 19. Each slot receives one module. Each slot provides electrical power and a connection for removal of existing data from the module and the delivery of new content and data to the module. The base station also withdraws tracking information from the module regarding user operations of the module, the various content displayed, and the times and amounts of content seen and not seen by the user. This information is then provided by the base station to a central server of the proprietor for use in market research and royalty calculations.

Alternatively, the retailing method includes a self standing machine into which customers inset a module. The machine then supplies electricity to the module, erases stored video and audio from the module, downloads operational data from the module, recharges the battery, and calculates any license fees or royalties due from viewing or listening to content from the module. When a customer selects a module to be removed from the machine, the machine communicates to a central computer system, or server, separated from the machine. The central computer system then downloads video and audio content through the machine into the module as selected by the customer. The customer or user then removes a module from the machine for viewing at any desired location. Though a customer paying upon viewing content, the Applicant also foresees the retailing method including a payment step where the customer pays before removing a module from the machine. The customer may pay both for the content and the module upon renting the module or alternately, the customer may place a deposit upon the module with the fees for content charged once the module returns to the machine. Customer payment may be taken by a credit card reading component of the machine, bill changing component, or cashless payment mechanism.

The present invention and its method of retailing allow consumers to access at any time or location content stored on the module without need for peripheral devices, such as those for computers or home entertainment systems. The module, loaded with fresh content selected by the user and a charged battery, can be taken by a user to any desired location for projection on any selected surface with the onboard photonic projector unit. The present invention also provides the capability for royalty and licensing fees based upon actual usage of content as tracked by the central server of the proprietor and the base station at each store location. The retailing method of the present invention also fits existing form factors at retail locations allowing for minimal conversion costs. Further, the present invention provides increased piracy protection as the content can be secured on a central server, can be delivered to a data component of a module only upon request, and can be tracked to time of usage and the user, or renter, of the module. And the module of the present invention has a reduced effect upon the environment as it can be reused many times as only the content changes while the components of the invention remain the same.

From the aforementioned description, a self contained projection module suitable for retail has been described. The self contained projection module is uniquely capable of projecting images from content stored within the module and not using peripheral projection equipment. The self contained projection module and its various components may be manufactured from many materials, including but not limited to, polymers, polyvinyl chloride, polyethylene, polypropylene, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A single compact self contained assembly projecting video and audio, including instructional media, comprising:
a digital memory component including a data port;
a data management component in communication with said memory component;
a video controller in communication with said data management component;
an audio controller in communication with said data management component;
a projection component in communication with said video controller and displaying an image away from said assembly;
an audio component in communication with said audio controller, said audio component projecting sound from said assembly;
a power source supplying electricity to said memory component, said data management component, said video controller, said audio controller, said projection component, and said audio component; and,
a casing containing said memory component, said data management component, said video controller, said audio controller, said projection component, and said power source therein;
wherein said assembly has a thickness less than approximately 0.60 inches.

2. The self contained assembly of claim 1 further comprising:
said projection component including one of a photonic projector or a pico projector.

3. The self contained assembly of claim 2 further comprising:
said photonic projector capable of projecting an image both forward and rearward of said assembly.

4. The self contained assembly of claim 1 wherein said memory component has at least 500 gigabytes of storage capacity.

5. The self contained assembly of claim 1 further comprising:
said power source including at least one battery and a connection for electrical utility service.

6. A method for providing video and audio content upon a portable display system for a user, including instructional media, comprising:
powering said system with electricity;
removing video and audio content from said system;
retrieving operational data from said system, said operational data including time of use of said system, duration of use, and content used;
uploading said operational data to a secure central computer system separated from said portable display system; and,
downloading video and audio content from said central computer system into said portable display system.

7. The video and audio providing method of claim 6 further comprising:
calculating fees payable by a user based upon said operational data; and,
determining licensing fees and royalties due for usage of video and audio content.

8. The video and audio providing method of claim 6 further comprising:
said downloading video and audio content to said portable display system using one of electrical signals, radio, infrared, or microwave.

9. A method for retailing video and audio content to a user upon a portable display system from a self standing machine, said video and audio content including instructional media, comprising:
delivering electrical power to said system from said machine;
removing video and audio content from said system;
retrieving operational data from said system into said machine, said operational data including time of use of said system, duration of use, and content used;
uploading said operational data from said machine to a secure central computer system separated from said machine;
calculating fees payable by a user based upon said operational data;
determining licensing fees and royalties due for usage of video and audio content; and,
downloading video and audio content from said central computer system through said machine and into said portable display system.
